(19) United States
(12) Patent Application Publication
(10) Pub. No.: US 2010/0072710 A1
(43) Pub. Date: Mar. 25, 2010

(54) Gas Turbine Seal

(75) Inventors: Victor John Morgan, Simpsonville, SC (US); Kevin Thomas McGovern, Simpsonville, SC (US); David Richard Johns, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/234,989

(22) Filed: Sep. 22, 2008

(51) Int. Cl. F16J 15/16

(52) U.S. Cl. 277/399

(57) ABSTRACT

A seal is provided for sealing two adjacent components of a gas turbine engine. The seal has first and second sealing surfaces that operate to seal the adjacent components to create an effective seal therebetween. Additionally, the seal has a first end and a second end, with the second end having a necked down portion, which is configured to internally engage the first end in a sliding, overlapping manner.

### BACKGROUND OF THE INVENTION

The subject matter disclosed herein relates to seals disposed between surfaces which may engage in relative movement with respect to one another.

A gas turbine engine includes multiple components requiring various seals to prevent undesirable leakage of either hot exhaust gas or compressed air. Axially adjoining components typically utilize a ring shaped, or annular seal compressed therebetween. The annular seal may be a complete 360 degree member or, it may be circumferentially split at one or more locations to allow for circumferential expansion of the seal due to thermal gradients experienced during the operation of the gas turbine engine. The annular seal is radially elastic so that it may freely expand with an adjoining component without restraint. However, each circumferential split interrupts the seal to form a gap that can result in a leakage site. Annular seals may also be axially elastic so that they may be axially compressed, between the adjoining components, for establishing an effective seal therebetween.

To reduce leakage through a circumferential split in an annular seal, one may employ a cover plate which is mechanically fixed to the seal member on one side of the gap and is in sliding contact with the seal member on the other side of the gap. Alternately, a two-ply seal configuration is known in which an inner seal member is disposed in sliding relationship within an outer seal member to span the gap and reduce leakage. Both configurations require multiple components as well as some type of mechanical connection therebetween. A commonly used method for connecting the components may include welding, which further adds to the complexity and cost of the seal. Additionally, the introduction of welds or other mechanical connections may introduce corresponding heat-affected zones. Weld joints are necessarily heat risers which must be accommodated in order to prevent excessive material stress which may affect the seal durability.

Accordingly, it is desired to improve such seals by eliminating multiple seal components as well as welding or other mechanical stress risers, and otherwise simplify the design and manufacture thereof.

### BRIEF DESCRIPTION OF THE INVENTION

An annular seal having a dimensional, transverse cross-section has first and second ends. The second end includes a necked-down portion which is received within the first end in overlapping engagement.

### BRIEF DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is an enlarged, axial sectional view through a portion of a gas turbine including a nested seal in accordance with an exemplary embodiment of the present invention;

FIG. 2 is an elevational end view of the seal illustrated in FIG. 1 in isolation;

FIG. 3 is an enlarged, partial, sectional view of the first and second nested ends of the seal within the dashed circle labeled 3 in FIG. 2;

FIG. 4 is an enlarged, partial, sectional view of the first and second nested ends of the seal illustrated in FIG. 3, with the ends un-nested to show additional detail;

FIG. 5 is a transverse cross-section of a nested seal in accordance with the on embodiment of the invention; and

FIG. 6 is a transverse cross-section of a nested seal in accordance with an alternate embodiment of the invention.

### DETAILED DESCRIPTION OF THE INVENTION

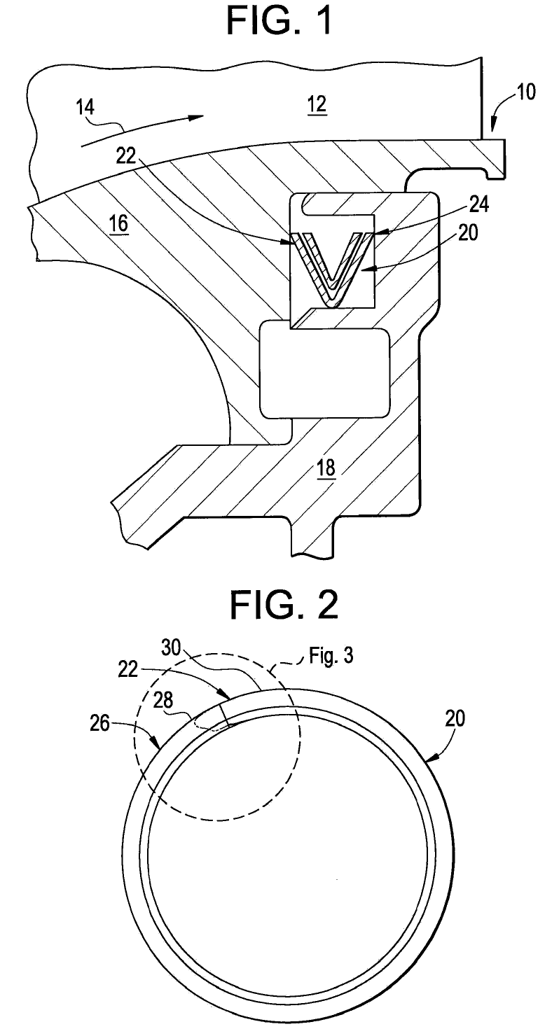

Illustrated in FIG. 1 is a portion of an exemplary high pressure turbine nozzle 10 of a gas turbine engine which may be sealed in accordance with an exemplary embodiment of the invention. The high pressure turbine nozzle 10 includes a plurality of circumferentially spaced apart nozzle vanes 12; only the radially inner portion of each vane being illustrated. The nozzle vanes 12 operate to direct and accelerate hot exhaust gas 14, received from an upstream combustor (not shown). The vanes 12 are integrally attached to a radially inner band 16, which in turn is mounted to an annular support flange 18.

In order to sealingly join the radially inner band 16 to the annular support flange 18, an annular seal 20, in accordance with an exemplary embodiment of the invention, is disposed therebetween to reduce or prevent leakage through the joint. The annular seal 20, is preferably formed of thin gauge sheet metal or other suitable material which has the appropriate strength, flexibility and formability. The annular seal 20 spans, in a radial direction, between the annular support flange 18 and the radially inner band 16. The seal may have various dimensionally transverse cross-sectional configurations such as E-seals, W-seals, V-seals or any other suitable cross-section.

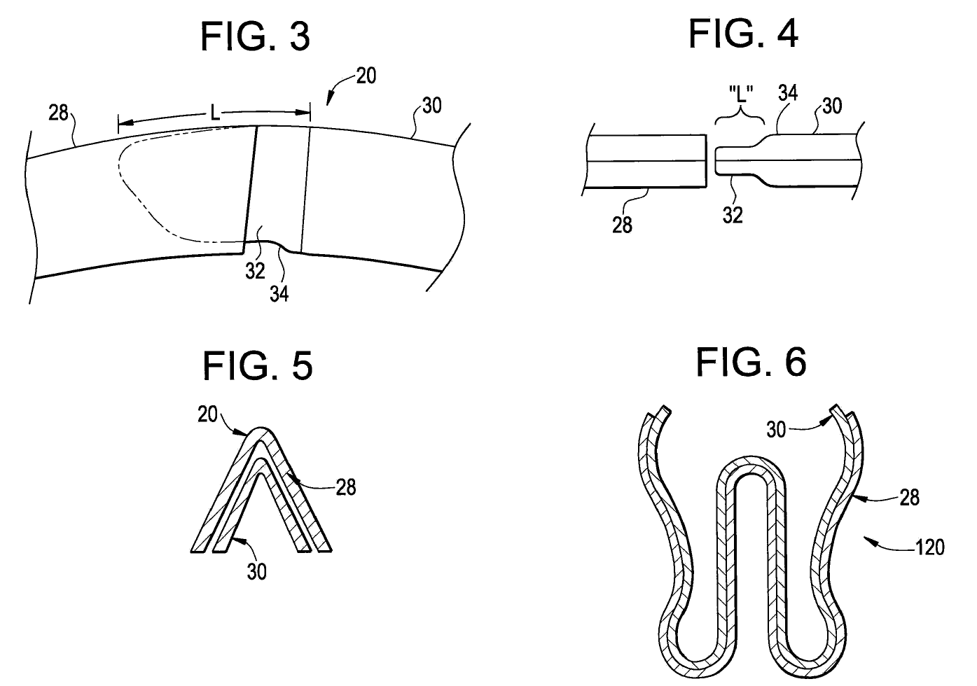

Depending upon the application of the annular seal 20 it may be constructed of a single piece of material or it may comprise more than one annular segment. The annular seal 20 includes sealing surfaces 22, 24 that contact the radially inner band 16 and the support flange 18 thereby creating an effective seal therebetween. In an exemplary embodiment, the annular seal 20 comprises a single, circumferentially extending element 26 defining a first end 28 and a second end 30, as shown in detail in FIGS. 3 and 4. A necked down portion 32 is formed in second end 30 and is configured to internally engage first end 28 in a slidably overlapping manner. Referring particularly to FIGS. 4 and 5, the necked down portion, which may be formed through any suitable mechanical forming process, will have a smaller but similar axial cross section as the first end 28, allowing the second end to nest within the first end 28 when assembled in the turbine engine 10. The second end 30 may be angled or tapered to aid its insertion into first end 28 during assembly.

In an exemplary embodiment of the invention shown in FIGS. 3 and 4, the necked down portion 32 ends at shoulder 34 and has a length “L”, which allows for overlapping engagement of, and relative movement of, the nested ends 28 and 30, across the entire engine temperature profile. The annular seal configuration as described, dispenses with the need for a gap between the ends 28 and 30, to account for differential thermal expansion between the nozzle inner band 16 and the support flange 18 and the resulting relative movement therebetween. Because the second end 30 is necked down, allowing the first and second ends 28 and 30 to nest in overlapping relationship to one another, no welding, brazing or other mechanical discontinuity is required. The result is a robust, simple seal 20 which disposes with the need for added mechanical stress risers which could ultimately affect its performance.

As indicated above, the annular seal 20 may have any of a number of dimensional transverse sections and still employ the benefit of slidably nested, relative ends which may be formed by necking down the second end 30 so as to nest in the first end 28. For example, FIG. 6 illustrates an alternate embodiment of the annular seal, designated 120, having a transverse cross-section in an E or W configuration. Although the transverse configuration of the annular seal 120 illustrated in FIG. 6 differs from that of annular seal 20 illustrated in FIGS. 1-4, the same reference numerals corresponding to the same features are used.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An annular seal having a dimensional transverse cross-section comprising;
a first end;
a second end; and
a necked down portion formed on said second end and configured to internally engage said first end in overlapping engagement.

2. An annular seal, as defined in claim 1, wherein said necked down portion has a length which allows for relative movement of said first and second ends.

3. An annular seal, as defined in claim 1, wherein said dimensional cross-section defines a V-shape.

4. An annular seal, as defined in claim 1, wherein said dimensional cross-section defines a W-shape.

5. An annular seal, as defined in claim 1, wherein said dimensional cross-section defines an E-shape.

6. A seal for sealing two adjacent components of a gas turbine engine comprising;
an annular seal having a dimensional transverse cross-section;
a first and a second sealing surface operable to sealingly engage said adjacent components to establish a seal therebetween;
a first end and a second end, said second end having a necked down portion formed thereon and configured to internally engage said first end in overlapping engagement.

7. A seal for sealing two adjacent components of a gas turbine engine, as defined in claim 6, wherein said necked down portion has a length which allows for relative movement of said adjacent components and said first and second ends.

8. A seal for sealing two adjacent components of a gas turbine engine, as defined in claim 6, wherein said dimensional cross-section defines a V-shape.

9. A seal for sealing two adjacent components of a gas turbine engine, as defined in claim 6, wherein said dimensional cross-section defines a W-shape.

10. A seal for sealing two adjacent components of a gas turbine engine, as defined in claim 6, wherein said dimensional cross-section defines a E-shape.
